(19) United States
(12) Patent Application Publication
(10) Pub. No.: US 2024/0344573 A1
(43) Pub. Date: Oct. 17, 2024

(54) FRICTION ASSEMBLY WITH CONNECTOR BLOCK AND SUCTION CIRCUIT

(71) Applicant: TALLANO TECHNOLOGIES, Paris (FR)

(72) Inventors: Loïc ADAMCZAK, BOULOGNE BILLANCOURT (FR); Adrien MAISTRE, BOULOGNE BILLANCOURT (FR); Pascal BONNAUD, BOULOGNE BILLANCOURT (FR)

(21) Appl. No.: 18/579,274

(22) PCT Filed: Jun. 28, 2022
(86) PCT No.: PCT/EP2022/067690

§ 371 Date: Jan. 12, 2024

(30) Foreign Application Priority Data
Jul. 16, 2021 (FR) FR2107701

(51) Int. Cl. F16D 65/095; B61H 5/00; F16D 65/00; F16D 69/00

(52) U.S. Cl. CPC F16D 65/095; B61H 5/00; F16D 65/0031; F16D 2069/004

(57) ABSTRACT

A friction assembly includes a brake head including a secondary channel, a friction plate including a primary channel and adapted for assembly to the brake head, at least one connecting ring inserted into the secondary channel and establishing a connection with the primary channel when the primary channel is aligned with the secondary channel, and a connector block which is fixed on the brake head. The block has a cavity connected to a suction device, and connected to the secondary channel by a hole, and the at least one ring is removably mounted on a connecting plate, the entity formed by the connecting plate and the at least one connecting ring being removably secured to the brake head.

### CROSS-REFERENCE TO RELATED APPLICATIONS

This application is the US national stage of PCT/EP2022/067690, filed Jun. 28, 2022 and designating the United States, which claims the priority of FR 2107701, filed Jul. 16, 2021. The entire contents of each foregoing application are incorporated herein by reference.

### BACKGROUND OF THE INVENTION

### Field of the Invention

This invention relates to the braking of railway rolling stock and in particular to the friction assemblies of braking systems for railway rolling stock. Rolling stock is understood to mean all vehicles configured to run on rails, such as trains, trams, and subway cars.

### Description of the Related Art

The braking system generally comprises a disc secured to a wheel or axle of the railway rolling stock. The braking system further comprises a friction assembly comprising a brake head that supports a friction plate. The friction plate usually comprises means of attachment to the brake head, and a friction pad. When a driver activates the braking system, the friction pad of the friction plate comes into contact with the disc to exert a braking force on the disc. Thus, by friction, the friction plate slows down the disc secured to the wheel or axle. Railway rolling stock generally comprise two friction assemblies, arranged one on either side of the disc so as to grip, or in other words sandwich, the disc in order to compress it on both sides. The friction pad of the friction plate usually comprises a metal material such as cast iron, a sintered material, or a composite material. Thus, when the friction pad of the friction plate rubs against the disc, particles of material from the friction pad and the disc are released into the ambient atmosphere around the friction assembly. The braking system thus emits atmospheric pollution in the form of particles of varying granularity.

Effort has therefore been made to capture the particles emitted during braking, in particular by placing a suction device, powered by a pump, near an area of emission of particles that come from the friction pad of the friction plate. In addition, effort has been made to ensure that this particle suction is as effective as possible.

One solution to this problem is the friction assembly illustrated in FIGS. 9 and 10, which represents the prior art. This prior art is described in document FR 3 088 394. FIG. 9 is a bottom view of this assembly, and FIG. 10 is a cross-section along line X-X of FIG. 9.

Brake head 103 extends longitudinally in a longitudinal direction X, and transversely in a transverse direction Y. Plane X-Y is horizontal. Direction Z, perpendicular to plane X-Y so as to form a frame of reference (X,Y,Z), is vertical, oriented upwards. Brake head 103 comprises a lower face 131 intended to accommodate a friction plate 102, and an upper face 132, each extending parallel to plane X-Y.

Brake head 103 has, on lower face 131, a concave dovetail receiving slide 105, which extends longitudinally from a first end of brake head 103 to the vicinity of the second end of brake head 103 where this slide has no opening. Brake head 103 comprises, on longitudinal axis X, two secondary channels 138 spaced apart from each other. Each secondary channel 138 connects upper face 132 to the bottom of slide 105 on the upper face.

Friction plate 102 is in two identical parts (for example symmetrical), each part having a friction face 121 intended to be in contact with the disc (not shown) of the vehicle and an opposite face 122. Opposite face 122 has a convex dovetail section 104 configured to engage with receiving slide 105. During use, a first portion of friction plate 102 is pushed in along longitudinal axis X by sliding dovetail section 104 in slide 105, until pressed against the end of slide 105. Then, the second portion of friction plate 102 is pushed in along longitudinal axis X by sliding dovetail section 104 in slide 105, until pressed against the first portion of friction plate 102, the contacting surfaces of the first portion and second portion ideally being shaped to fit together along their entire surface.

Each of the portions of friction plate 102 comprises a primary channel 128 oriented along vertical axis Z. When these portions are assembled with brake head 103 during use, each of the two primary channels 128 is positioned in line with a secondary channel 138. Axis B denotes the main axis of a primary channel 128 and the secondary channel 138 located facing it, primary channel 128 and secondary channel 138 therefore being coaxial. Thus, each primary channel 128 forms, with one of secondary channels 138 provided in brake head 103, a circuit which makes it possible to suction particles emitted by friction plate 102 during braking. Axis B is therefore parallel to vertical axis Z.

A connecting ring 108, consisting of a tube and a flange 1082 which extends this tube radially outwards at one of its ends, is mounted in secondary channel 138. The tube is inserted into secondary channel 138, the outside diameter of the tube being equal to the inside diameter of secondary channel 138 so as to ensure the best possible sealing. Flange 1082 is housed in an annular housing of brake head 103, this housing being centered on main axis B and facing opposite face 122 of friction plate 102. The annular housing has a diameter greater than that of secondary channel 138 and less than that of flange 1082. Thus, flange 1082 is sandwiched between the dovetail section of friction plate 102 and the bottom of slide 105 of brake head 103. Once in its housing, flange 1082 is in contact with face 122 of dovetail section 104 of friction plate 102. This contact is achieved for example by deformation (crushing) of flange 1082 between the bottom of the housing and face 122.

Alternatively (as shown in FIG. 10), this contact is made by compression of a helical spring mounted on the tube between flange 1082 and the bottom of the housing. Thus, the flange 1082 itself, or the helical spring, is a return mechanism 190 which allows flange 1082 to be pressed against dovetail section 104 (see below).

Connecting ring 108 completely traverses brake head 103 and protrudes beyond its upper face 132, to its lower face 131 which is provided with slide 105. Fixed on this end of the tube of ring 108 is a pipe 150 that is connected to a suction device (not shown) and which allows suctioning, through primary channel 128 and secondary channel 138, the particles which come from the braking of the railway vehicle due to wear of friction plate 102. Pipe 150 and the suction device constitute a particle removal device.

Connecting ring 108 serves to guide the particles which come from braking, from primary channel 128 of friction plate 102 to secondary channel 138 of brake head 103. Connecting ring 108 therefore aims to prevent possible leaks through primary channel 128 and secondary channel 138. In particular, connecting ring 108 aims to reduce the amount of particles resulting from braking which could slip into the gap at the interface between friction plate 102 and brake head 103, and above all to prevent a flow of air from the outside from entering through this gap into secondary channel 138, which would degrade the suction by the suction device.

In addition, connecting ring 108 is pressed against dovetail section 104 by means of a return mechanism 190, as indicated above. Return mechanism 190 effectively prevents the passage of air at the interface between friction plate 102 and brake head 103 at primary channel 128 and secondary channel 138, this passage of air being due to clearances at the interface between brake head 103 and friction plate 102.

Ring 108 must be prevented from translational movement in both directions along axis B, so as to be integral with brake head 103. This is achieved in one direction by flange 1082 at the lower end of ring 108. This is achieved in the other direction by the upper end of ring 108 being fixed on pipe 150 which is connected to the suction device.

We thus have a friction assembly for a braking system for railway rolling stock, the friction assembly comprising: on the one hand a brake head comprising a lower face, an upper face, and at least one secondary channel of central axis B which connects the lower face and an upper face; on the other hand at least one friction plate made of friction material comprising a first face which is the friction face, a second face which is adapted to be assembled to the lower face by an assembly mechanism, and at least one primary channel which connects the first face and the second face; this assembly further comprising at least one connecting ring which is inserted into the secondary channel and which establishes a connection with the primary channel when the at least one primary channel is aligned with the at least one secondary channel; the friction assembly further comprising a connector block which is connected to a suction device and which is fixed to the brake head at the upper face.

However, there is a need to improve and simplify the assembly between the brake head, the connector block, and the connecting ring(s).

### SUMMARY OF THE INVENTION

The present invention aims to remedy these disadvantages.

The invention aims to propose a friction assembly for a railway braking system in which the connector block, which is connected to a suction system, for example a pneumatic manifold block, is fixed to the brake head, this assembly being such that the mounting on the brake head of at least one connecting ring is simple and such that it allows carrying away the particles emitted by wear of the friction plate, towards the suction device.

This goal is achieved due to the fact that the block has a cavity which is connected by a circuit to the suction device and which comprises at least one hole which connects the cavity and the upper face and which is aligned with the at least one secondary channel, and the fact that the at least one connecting ring is removably mounted on a connecting plate, the entity formed by the connecting plate and the at least one connecting ring being removably secured to the brake head.

By means of these arrangements, each connecting ring is adapted to be inserted into each hole and into a secondary channel so as to place the friction plate in communication with the suction device. This insertion is carried out in a simple manner due to the manipulation of a single entity which consists of the connecting plate and the rings (or ring) carried by this connecting plate and which is kept removably secured to the brake head. Thus, the particles originating from the friction plate are reliably carried away to the suction device during the operation of the friction assembly. In particular, maintenance of the assembly is facilitated due to the ability to remove the rings from the connecting plate, and the entity composed of this connecting plate and rings from the brake head.

For example, the connecting plate is housed between the connector block and the brake head, and the block is removably fixed to the brake head so as to hold the connecting plate between the block and the brake head.

The rings are thus kept reliably secured to the brake head, while allowing their easy replacement.

For example, the lower face has a housing, the connecting plate being housed in this housing without protruding from the rest of the lower face when the at least one connecting ring is inserted in the at least one secondary channel, and the friction plate covers the connecting plate when the friction plate is assembled to the brake head by the assembly mechanism.

The rings can thus be secured to the brake head independently of the block being secured to the brake head.

For example, the block is an integral part of the brake head.

Thus, in this case where one face of the brake head (on the block side) is not accessible, it is still possible to secure the rings to the brake head.

For example, the connecting plate is mechanically secured to the brake head or to the block by means of a securing mechanism.

The ring(s) are thus kept secured to the brake head more effectively, due to the securing mechanism.

For example, the housing comprises a tapped hole and the connecting plate is pierced with a screw hole which is in line with the tapped hole when the connecting plate is housed in the housing, and the securing mechanism consists of the tapped hole and a screw V adapted to screw into the tapped hole through the connecting plate via the screw hole.

The securing mechanism is therefore simple.

For example, the friction assembly further comprises a return mechanism which is adapted to press the rings against the second face.

The seal between rings 8 and friction plate 2 is thus improved.

For example, the assembly mechanism comprises a receiving slide which is formed on the lower face, and a dovetail section which is formed on the second face and which is configured to engage with the receiving slide.

The assembly of the friction plate to the brake head is thus facilitated since it is achieved by sliding, while being removable.

The invention also relates to a method for mounting a connecting ring on a brake head with a connector block connected to a suction device, the brake head comprising a lower face, an upper face, and at least one secondary channel of central axis A, the brake head and the connecting ring forming part of a friction assembly for a braking system for railway rolling stock, the friction assembly further comprising a friction plate made of friction material comprising a first face which is the friction face, a second face which is adapted to be assembled to the lower face by an assembly mechanism, and at least one primary channel which connects the first face and the second face, the at least one connecting ring being adapted to be inserted into the at least one secondary channel and to establish a connection with the at least one primary channel when the at least one primary channel is aligned with one of the at least one secondary channel(s).

According to the invention, the method comprises the following steps:
(a) The block is provided with a cavity which is connected by a circuit to the suction device, and with at least one hole which connects the cavity and the upper face and which is aligned with the at least one secondary channel;
(b) A connecting plate is provided and the at least one connecting ring is removably mounted on the connecting plate;
(c) The connecting plate is then placed against the upper face of the brake head, and simultaneously the at least one connecting ring is inserted in the at least one secondary channel by sliding along axis A from the upper face, then the block is placed on the connecting plate such that the entity formed by the connecting plate and the at least one connecting ring is sandwiched between the brake head and the block;
(d) The block is removably secured to the brake head;
(e) The friction plate is assembled to the brake head by the assembly mechanism until the friction plate is covering the secondary channels.

The invention also relates to another method for mounting a connecting ring on a brake head comprising a lower face and an upper face, and having a connector block located at the upper face side and connected to a suction device, the brake head comprising at least one secondary channel of central axis A, the block forming an integral part of the brake head at the upper face, the brake head and the connecting ring forming part of a friction assembly for a brake system for railway rolling stock, the friction assembly further comprising a friction plate made of friction material comprising a first face which is the friction face, a second face which is adapted to be assembled to the lower face by an assembly mechanism, and at least one primary channel which connects the first face and the second face, the at least one connecting ring being adapted to be inserted in the at least one secondary channel and to establish a connection with the at least one primary channel when the at least one primary channel is aligned with one of the at least one secondary channel(s).

According to the invention, the method comprises the following steps:
(a) The block is provided with a cavity which is connected by a circuit to the suction device, and with at least one hole which connects the cavity and the upper face and which is aligned with the at least one secondary channel, and the lower face is provided with a housing;
(b) A connecting plate is provided and the at least one connecting ring is removably mounted on the connecting plate;
(c) The connecting plate is then housed in the housing such that the connecting plate does not protrude from the rest of the lower face, and simultaneously the at least one connecting ring is inserted in the at least one secondary channel by sliding along axis A from the lower face, the entity formed by the connecting plate and the at least one connecting ring being removably secured to the brake head;
(d) The friction plate is assembled to the brake head by the assembly mechanism until the friction plate is covering the secondary channels and the connecting plate.

For example, the block is an integral part of the brake head at the upper face.

For example, during step (a), the block is removably fixed to the brake head at its upper face.

For example, the method comprises, after step (c) and before step (d), the following step (c2):

(c2) The connecting plate is mechanically secured to the brake head or to the block by means of a securing mechanism.

### BRIEF DESCRIPTION OF THE DRAWINGS

The invention will be well understood and its advantages will be more apparent from reading the following detailed description of some embodiments represented by way of non-limiting examples. The description refers to the attached drawings, in which:

FIG. 1 is an exploded perspective view of a friction assembly according to a first embodiment of the invention, with the friction plate disassembled from the brake head.

FIG. 2 is a perspective, partial section view in plane (X, Z) of the region of the friction assembly of FIG. 1 which comprises the block.

FIG. 3 is an exploded perspective view of the connecting plate and the rings of the friction assembly of FIG. 1.

FIG. 4 is an exploded perspective view of a friction assembly according to a variant of FIG. 1, with the friction plate disassembled from the brake head.

FIG. 5 is a perspective, partial section view in plane (X, Z) of the region of the friction assembly according to FIG. 4 which comprises the block.

FIG. 6 is an exploded perspective view of a friction assembly according to a second embodiment of the invention, without the friction plate.

FIG. 7 is a perspective section view in plane (X, Z) of the region of the friction assembly according to FIG. 6 which comprises the rings.

FIG. 8 is an exploded perspective view of the connecting plate and the rings of the friction assembly according to an alternative embodiment.

FIG. 9, already described, is a bottom view of a friction assembly according to the prior art.

FIG. 10, already described, is a cross-section along line X-X of FIG. 9.

### DETAILED DESCRIPTION OF THE INVENTION

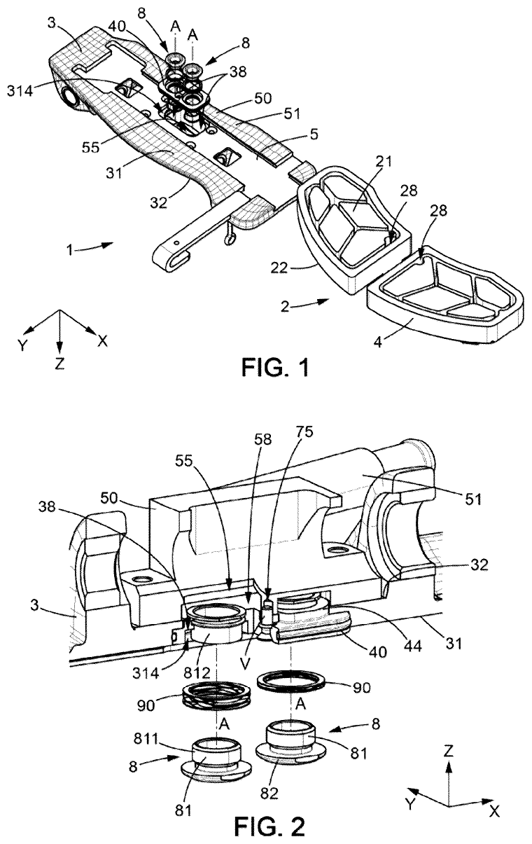

FIG. 1 illustrates a friction assembly 1 for a braking system for railway rolling stock. For example, these brakes are disc brakes. For example, these brakes are brakes on a running surface of the rolling stock wheel. The assembly extends longitudinally along a longitudinal axis X, and vertically along a vertical axis Z directed upwards. The transverse axis Y forms a trigonometric frame of reference with axes X and Z, this frame of reference being used for FIGS. 1, 2, 4, 5 and 6. Friction assembly 1 is shown in a perspective view from below, with the various parts shown separated for clarity.

Friction assembly 1 comprises a brake head 3, and at least one friction plate 2 made of friction material. Brake head 3 has a lower face 31 and an upper face 32. Friction plate 2 has a first face 21 which is the friction face, and a second face 22. Friction plate 2 may be one part, or two separate halves as shown in FIG. 1. In operation, friction plate 2 is assembled to brake head 3 by an assembly mechanism (4, 5). For example, this assembly mechanism comprises a receiving slide 5 which is formed on lower face 31, and a dovetail section 4 which is formed on second face 22 and which is configured to engage with receiving slide 5. Thus, friction plate 2 is assembled to brake head 3 by insertion and translational movement of dovetail section 4 in slide 5 along longitudinal axis X. The assembly mechanism is then such that this assembly can be undone. Generally speaking, the assembly of friction plate 2 to brake head 3 can be undone, which allows replacement of friction plate 2 once it is worn out.

Friction plate 2 comprises at least one primary channel 28 which connects first face 21 and second face 22. The side wall of primary channel 28 is fluid-tight and is open only at grooves possibly present on first face 21. In FIG. 1, friction plate 2 comprises two primary channels 28 (one in each half of friction plate 2). Brake head 3 comprises at least one secondary channel 38 of central axis A which connects, in a fluid-tight manner, upper face 32 and lower face 31 at the bottom of receiving slide 5. In FIG. 1, brake head 3 comprises two secondary channels 38. Friction assembly 1 comprises at least one connecting ring 8 inserted into the at least one secondary channel 38 and establishing a connection with the at least one primary channel 28. In FIG. 1, brake head 3 comprises two connecting rings 8. When friction plate 2 is assembled to brake head 3, each primary channel 28 is aligned with a secondary channel 38, meaning that the central axis of each primary channel 28 is the central axis A of the secondary channel 38 with which it is aligned.

A connecting ring 8 comprises a tubular body 81. For example, the inside diameter of body 81 is greater than the diameter of primary channel 28 in order to compensate for clearances between friction plate 2 and brake head 3 along axis X. Each connecting ring 8 is extended at one end of body 81 by a flange 82 which extends radially outwards. The other end of body 81 is the distal end of body 81.

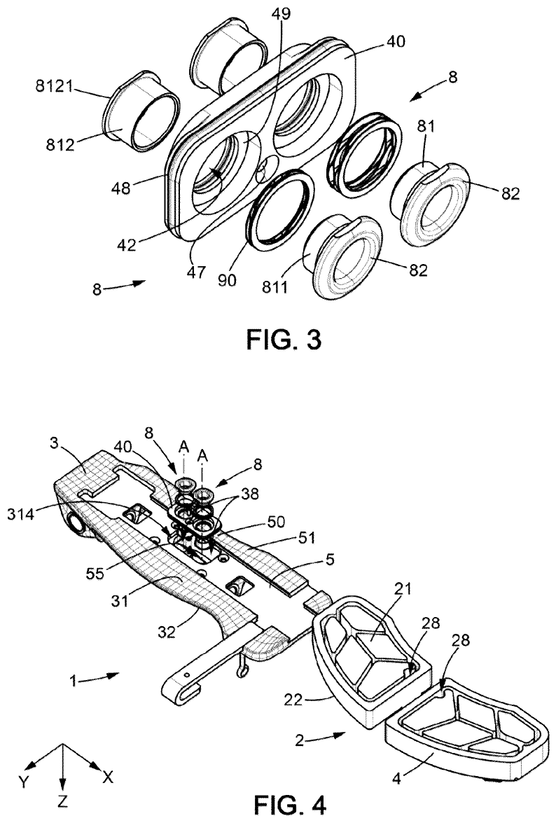

Each connecting ring 8 is removably mounted on a connecting plate 40, such that connecting plate 40 carries all connecting rings 8. Each ring 8 is mounted on connecting plate 40 such that connecting plate 40 bears against flange 82. The distal end of body 81 is therefore located on the other side of connecting plate 40 relative to flange 82. Connecting plate 40 extends substantially in a plane, and the longitudinal axis of each body 81 is perpendicular to this plane. Connecting plate 40 and connecting rings 8 are illustrated in FIG. 2 for the case of two rings 8. In FIG. 1, body 81 of each ring 8 is in two parts, each in the extension of the other. The entity formed by rings 8 and connecting plate 40 is described in detail below with reference to FIG. 3. Alternatively, body 81 is one part, as illustrated in FIG. 8 and described below.

In the description below, the plural is used for the elements “primary channels 28”, “secondary channels 38”, “connecting rings 8”, “holes 58”, as well as the determinant “each”, for the discussion of cases of two or more of these elements. The description below is also valid for the case of a single primary channel 28, a single secondary channel 38, a single connecting ring 8, and a single hole 58.

We now describe a first embodiment of the invention, with reference to FIGS. 1 to 5.

Lower face 31 of brake head 3 has a housing 314. This housing is a depression. One end of each secondary channel 38 leads into housing 314.

Friction assembly 1 further comprises a connector block 50. For example, block 50 is a pneumatic manifold block. Block 50 covers upper face 32 of brake head 3 at the portion of upper face 32 which comprises the openings of secondary channels 38. Block 50 comprises a cavity 55 which is connected to a circuit 51 which is connected to a suction device. Block 50 has holes 58 which connect cavity 55 and upper face 32, each hole 58 being located in line with one of secondary channels 38. As illustrated in FIG. 1, block 50 therefore has two holes 58.

In one case, block 50 is removably fixed (for example by mechanical connection, for example using screws and nuts) to brake head 3.

Alternatively, in another case, block 50 is an integral part of brake head 3 at upper face 32. “Is an integral part” is understood to mean that block 50 cannot be separated from brake head 3, except with tools. For example, block 50 is molded with brake head 3, or is welded to brake head 3. In this case, the solution of the invention is of particular interest because, as block 50 forms an integral part of brake head 3, a ring 8 cannot be inserted into a secondary channel 38 via upper face 32.

Each ring 8 is, in both cases, inserted into a secondary channel 38 only via lower face 31, before assembling friction plate 2 to brake head 3. The diameter of each of holes 58 of block 50 is greater than or equal to the outside diameter of body 81. Thus, when body 81 of each ring 8 is inserted into a secondary channel 38, body 81 also slides in a hole 58. Connecting plate 40 is thus located by lower face 31. Connecting rings 8 are slid in holes 58 of block 50 and in secondary channels 38, and connecting plate 40 is housed in housing 314 without connecting plate 40 protruding from the rest of lower face 31.

FIG. 1 and FIG. 2 illustrate the situation where housing 33 is not open at upper face 32. FIG. 2 is a perspective partial section view in plane (X, Z) of the region of the friction assembly of FIG. 1 which comprises block 50. In this case, housing 314 is a cavity which has a bottom, and the depth of housing 314 is the distance (along direction Z) between the bottom of the cavity and lower face 31 around the cavity. The depth of housing 314 is strictly less than the thickness of brake head 3 (this thickness is the distance between lower face 31 and upper face 32). The thickness of connecting plate 40 is less than the depth of housing 314, so that when connecting plate 40 is in contact with the bottom of housing 314 (meaning the bottom of the cavity), connecting plate 40 does not protrude from housing 314. Thus, connecting plate 40 is placed in housing 314 until it abuts against the bottom of housing 314. Simultaneously, flanges 82 slide in secondary channels 38, and bodies 81 of connecting rings 8 are engaged in secondary channels 38 and in holes 58 of block 50.

We now describe the entity formed by rings 8 and connecting plate 40, with reference to FIG. 3 which illustrates rings 8 disassembled from connecting plate 40.

Connecting plate 40 is provided with as many holes 42 as there are connecting rings 8. In the case illustrated, there are two holes 42 for two rings 8. As both rings 8 are identical and both holes 42 are identical, some of the references are not duplicated. Body 81 of each ring 8 is in two parts which lie in the extension of one another. Proximal part 811 of body 81 carries flange 82. Distal part 812 of body 81 lies in the extension of proximal part 811 and carries at its distal end a radial lip 8121. The outside diameter of distal part 812 and the outside diameter of proximal part 811 are each less than or equal to the diameter of hole 42, such that each of these parts is capable of sliding in hole 42. For example, the outside diameter of distal part 812 is equal to the outside diameter of proximal part 811. Proximal part 811 of body 81 is inserted into hole 42 until flange 82 abuts against the edge of hole 42. Then, via the other side of connecting plate 40, distal part 812 is assembled to proximal part 811. This assembly is carried out for example by screwing or by snap-fastening. The outside diameter of flange 82 and the outside diameter of lip 8121 are each greater than the diameter of hole 42, such that ring 8, after assembly, cannot slide of out connecting plate 40. Rings 8 are thus removably secured to connecting plate 40. After assembly, the annular top of flange 82 (meaning the portion of the flange furthest from the distal end of body 81) protrudes beyond the surface of connecting plate 40. For example, this annular top is the only part of ring 8 which protrudes beyond the surface of connecting plate 40 at the flange 82 side.

A return mechanism 90 is mounted between connecting plate 40 and the flange 82 of ring 8. For example, this return mechanism is a spring (for example a helical spring) which is mounted on body 81. At rest, return mechanism 90 is in contact with connecting plate 40 and flange 82, and connecting plate 40 protrudes from lower face 31 (for example at the bottom of slide 5 if slide 5 is present). When friction plate 2 is assembled to brake head 3 (for example by sliding dovetail section 4 of friction plate 2 in slide 5), second face 22 is in contact with lower face 31, rings 8 are pushed back against connecting plate 40 which is in housing 314 and thus compresses return mechanism 90. In FIG. 2 and FIG. 3, return mechanism 90 is shown in the rest state for one ring 8, and in the compressed state for the other ring 8. For example, return mechanism 90 is housed in an annular housing 49 which surrounds hole 42, so that only the annular top of flange 82 protrudes beyond the surface of connecting plate 40.

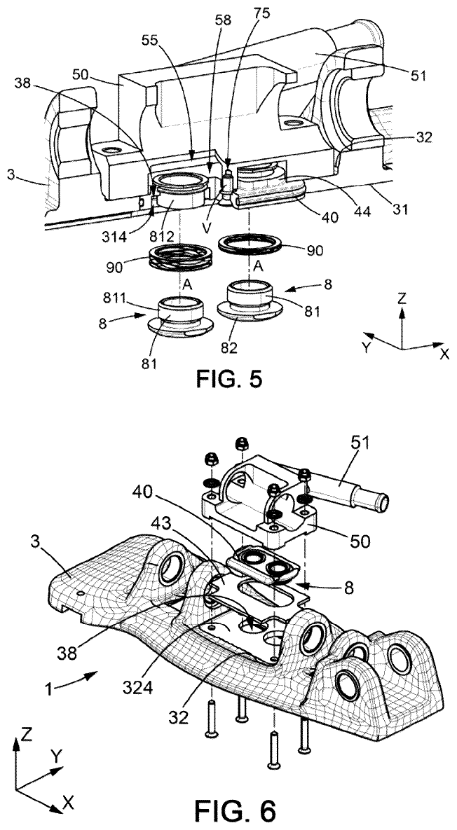

FIG. 4 and FIG. 5 illustrate the variant where the depth of housing 314 is equal to the thickness of brake head 3. The other characteristics of brake head 3 are identical between FIG. 1 and FIG. 4. FIG. 5 is a perspective partial section view in plane (X, Z) of the region of the friction assembly of FIG. 4 which includes block 50. In this case, housing 314 is open at upper face 32, meaning that housing 314 is a through-hole in brake head 3. Thus, connecting plate 40 is placed in housing 314 until it abuts against the edge of holes 58. Simultaneously, flanges 82 slide in secondary channels 38, and bodies 81 of connecting rings 8 slide in secondary channels 38 and in holes 58 of block 50.

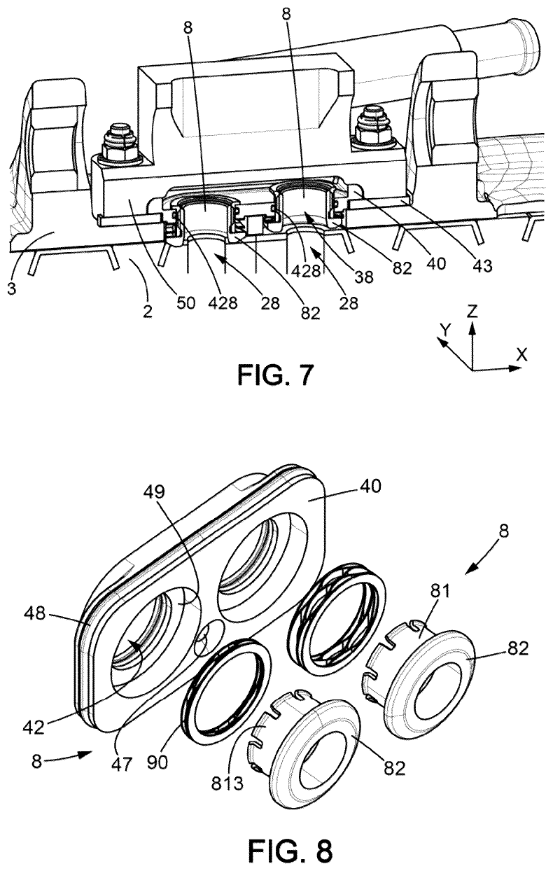

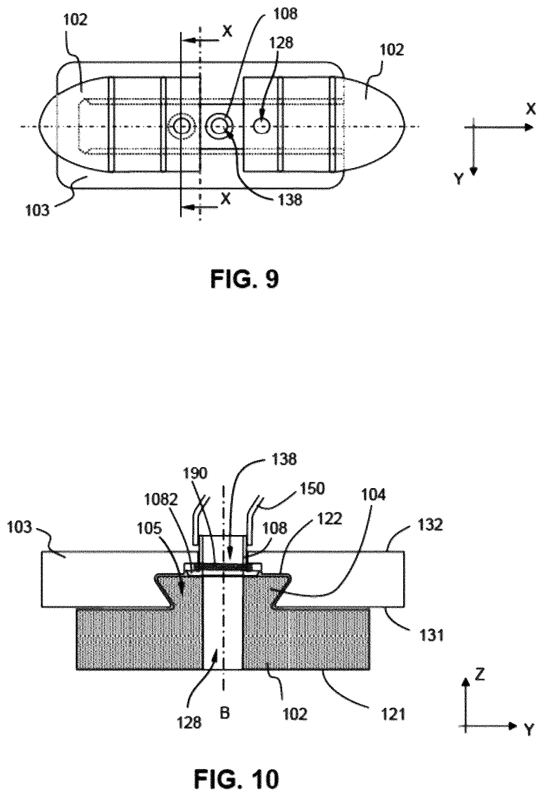

Note that, in all cases, the top of flange 82 is kept pressed against second face 22 of friction plate 2, by return mechanism 90. Flange 82 thus also fulfills a sealing function between rings 8 and second face 22. Advantageously, this sealing is reinforced by a seal 48 which surrounds the periphery of connecting plate 40 and which bears against the side face of housing 314, as shown in FIG. 2 and FIG. 5. Seal 48 can also be seen in FIGS. 3 and 7.

In all cases, connecting plate 40 blocks translational movement of connecting rings 8 in secondary channel 38 along axis A, in both directions.

The side face of each hole 42 of connecting plate 40 may comprise an annular housing in which an O-ring 428 is partially housed. Each O-ring 428 then bears against the side face of body 81 of ring 8 so as to create a seal between ring 8 and connecting plate 40. These O-rings 428 can be seen in FIG. 7.

In a method according to the invention for mounting one or more connecting rings 8 on a brake head 3, with a connector block 50 located at the upper face 32 side of brake head 3, in the case where block 50 is an integral part of brake head 3 at its upper face 32, the first step (step (a)) consists of providing block 50 with a cavity 55 which is connected by a circuit 51 to the suction device, and one or more holes 58 connecting cavity 55 and upper face 32 of brake head 3 and each aligned with a secondary channel 38 of brake head 3, and providing lower face 31 with a housing 314.

This method also applies to the case where block 50 is removably fixed beforehand to brake head 3 at its upper face 32. In this case, block 50 is removably fixed to brake head 3 at its upper face 32 during step (a).

In a second step (step (b)), a connecting plate 40 is provided and each connecting ring 8 is removably mounted on connecting plate 40.

In a third step (step (c)) after step (b), connecting plate 40 is housed in housing 314 such that connecting plate 40 does not protrude from the rest of lower face 31, and simultaneously each connecting ring 8 is inserted into a secondary channel 38 by sliding along axis A from lower face 31, such that the entity formed by connecting plate 40 and connecting ring(s) 8 is removably secured to brake head 3. For example, connecting plate 40 has, around each of its holes 42, an annular shoulder 44 having an outside diameter substantially equal and less than the diameter of hole 58, which facilitates assembly of the entity formed by connecting plate 40 and rings 8 to brake head 3 and block 50.

Body 81 of each ring 8 then extends at least as far as the edge of hole 58. For example, body 81 penetrates hole 58, as shown in FIGS. 2 and 5.

In the case where a return mechanism 90 is present, return mechanism 90 must be compressed so that flanges 82 do not protrude from the rest of lower face 31.

In a next step (step (d)), friction plate 2 is assembled to brake head 3 by the assembly mechanism (4, 5) until friction plate 2 is covering secondary channels 28 and connecting plate 40.

In the case where a return mechanism 90 is present, return mechanism 90 presses flanges 82 of rings 8 against second face 22 of friction plate 2. A seal is thus established between rings 8 and friction plate 2.

According to a variant, friction assembly 1 comprises a securing mechanism 70 for securing connecting plate 40 to brake head 3 or to block 50 when connecting plate 40 is housed in housing 314. Thus, securing mechanism 70 prevents connecting plate 40 from coming out of from housing 314 and therefore prevents connecting rings 8 from coming out of secondary channels 38. Advantageously, securing mechanism 70 can be undone, which makes it possible to easily change connecting plate 40 and rings 8 if so desired.

Thus, after step (c) and before step (d), connecting plate 40 is mechanically secured to brake head 3 or to block 50 by means of securing mechanism 70 (step (c2)).

Securing mechanism 70 prevents connecting plate 40 from protruding outside of housing 314.

We now describe an example of securing mechanism 70 and the method for securing connecting plate 40 to brake head 3 or to block 50.

Housing 314 comprises a tapped hole 75. In the case where housing 314 does not open onto upper face 32 (FIG. 2), tapped hole 75 is located at the bottom of housing 314, and in addition possibly in block 50. In the case where housing 33 traverses brake head 3 (FIG. 5), tapped hole 75 is located in block 50. Connecting plate 40 is pierced with a screw hole 47 (visible in FIG. 3) which a screw V can pass through, such that screw V traverses connecting plate 40. Screw V has a head which bears against connecting plate 40 when screw V passes through screw hole 47, and which prevents screw V from completely traversing connecting plate 40. Connecting plate 40 has a depression which is adapted to receive the head of screw V. For example, the head of screw V is conical and the depression flares conically so as to fit against the shape of this head. The head of screw V thus does not protrude from connecting plate 40. Screw V thus does not interfere with the sliding of friction plate 2 relative to brake head 3. Screw hole 47 is in line with tapped hole 75 when connecting plate 40 is housed in housing 314. Screw V is able to screw into tapped hole 75. Securing mechanism 70 is composed of tapped hole 75 and screw V.

Thus, in step (c2), the connecting plate 40 is mechanically secured to brake head 3 or to block 50 by passing screw V through screw hole 47 until the head of screw V is housed in the depression of connecting plate 40. The rest of screw V thus traverses connecting plate 40. Then screw V is screwed into tapped hole 75. Screw V prevents connecting plate 40 from detaching from brake head 3.

We now describe a second embodiment of the invention, with reference to FIG. 6 and FIG. 7.

FIG. 6 illustrates a friction assembly 1 in an exploded perspective view from above. Friction plate 2 is not shown. Upper face 32 of brake head 3 has a housing 324 adapted to receive connecting plate 40. Secondary channels 38 each have a mouth at housing 324. When connecting plate 40 provided with rings 8 is housed in housing 324, flanges 82 and body 81 of rings 8 are inserted into secondary channels 38 of brake head 3. Block 50 is then removably fixed on upper face 32 of brake head 3, on top of connecting plate 40. This attachment is achieved by a mechanical attachment mechanism. For example, this mechanism is composed of a plurality of screws and nuts, brake head 3 and block 50 having holes to receive these screws. For example, the number of screws and nuts is four, distributed around connecting plate 40. After this attachment, each flange 82 then comes into contact with second face 22 of friction plate 2.

In the case where a return mechanism 90 is present, return mechanism 90 presses flanges 82 of rings 8 against second face 22. This situation can be seen in FIG. 7, which is a perspective, partial section view of the region of FIG. 6 which includes block 50 and secondary channels 38.

Advantageously, the sealing between block 50 and brake head 3 is created or reinforced by a seal 43 which surrounds the periphery of connecting plate 40 (or annular shoulders 44 if they are present) and which rests against the bottom of housing 324, as shown in FIG. 6 and FIG. 7.

In the above description, each connecting ring 8 has a body 81 which is in two parts. Alternatively, in a variant embodiment, each connecting ring 8 is one part. This variant is illustrated in FIG. 8, and can be applied to the first embodiment and second embodiment which are described above. In this variant, body 81 is a single part, and at its distal end has elastic petals 813 which, at rest, extend body 81 and flare radially outwards. When beginning to insert ring 8 into hole 42 of connecting plate 40, petals 813 are deformed (pushed) elastically inwards, which allows the distal end to pass through hole 42. When petals 813 have passed beyond hole 42, they return to their initial (rest) position. If removal of ring 8 from hole 42 is attempted, petals 813 abut against the edge of hole 42 and prevent each ring 8 from being removed from hole 42.

In a method according to the invention for mounting one or more connecting rings 8 on a brake head 3 in the case where block 50 is removable from brake head 3, the first step (step (a)) consists of providing block 50 with a cavity 55 which is connected by a circuit (51) to the suction device, and with at least one hole 58 which connects cavity 55 and upper face 32 and which is aligned with secondary channel 38.

In a second step (step (b)), a connecting plate 40 is provided and each connecting ring 8 is removably mounted on connecting plate 40.

In a third step (step (c)) after step (b), connecting plate 40 is placed in a housing 324 on upper face 32 of brake head 3, and simultaneously each connecting ring 8 is inserted into a separate secondary channel 38 by sliding along axis A from upper face 32. Then block 50 is placed on connecting plate 40 such that the entity formed by connecting plate 40 and connecting ring(s) 8 is sandwiched between brake head 3 and block 50.

Flange 82 of each ring 8 is then in contact with second face 22 of friction plate 2, as illustrated in FIG. 7.

In a following step (step (d)), block 50 is removably secured to brake head 3.

In a following step (step (e)), friction plate 2 is assembled to brake head 3 by the assembly mechanism (4, 5) until friction plate 2 is covering secondary channels 28 and connecting plate 40.

1-13. (canceled)

14. A friction assembly for a braking system for railway rolling stock, said friction assembly comprising:
a brake head comprising a lower face, an upper face, and at least one secondary channel of central axis A which connects said lower face and an upper face;
at least one friction plate made of friction material comprising a first face which is the friction face, a second face which is adapted to be assembled to said lower face by an assembly mechanism, and at least one primary channel which connects said first face and said second face;
at least one connecting ring which is inserted into said at least one secondary channel and which establishes a connection with said at least one primary channel as said at least one primary channel is aligned with said at least one secondary channel;
a connector block which is connected to a suction device and which is fixed to said brake head at said upper face, said block having a cavity which is connected by a circuit to the suction device and which comprises at least one hole which connects said cavity and said upper face and which is aligned with said at least one secondary channel, and wherein said at least one connecting ring is removably mounted on a connecting plate, said connecting plate and said at least one connecting ring being removably secured to said brake head.

15. The friction assembly according to claim 14, wherein said connecting plate is housed between said block and said brake head, and wherein said block is removably fixed to said brake head so as to hold said connecting plate between said block and said brake head.

16. The friction assembly according to claim 14, wherein said lower face has a housing, said connecting plate being housed in said housing without protruding from the rest of said lower face as said at least one connecting ring is inserted in said at least one secondary channel, and wherein said friction plate covers said connecting plate as the friction plate is assembled to said brake head by said mechanism assembly.

17. The friction assembly according to claim 16, wherein said block is an integral part of said brake head.

18. The friction assembly according to claim 16, wherein the connecting plate is mechanically secured to at least one of: said brake head and said block, by means of a securing mechanism.

19. The friction assembly according to claim 18, wherein said housing comprises a tapped hole and said connecting plate is pierced with a screw hole which is in line with said tapped hole when said connecting plate is housed in said housing, and said securing mechanism consists of said tapped hole and a screw adapted to screw into said tapped hole through said connecting plate via the screw hole.

20. The friction assembly according to claim 14, further comprising a return mechanism which is adapted to press said rings against said second face.

21. The friction assembly according to claim 14, wherein said assembly mechanism comprises a receiving slide which is formed on said lower face, and a dovetail section which is formed on said second face and which is configured to engage with said receiving slide.

22. A method for mounting at least one connecting ring on a brake head with a connector block connected to a suction device, said brake head comprising a lower face, an upper face, and at least one secondary channel of central axis A, said brake head and said connecting ring forming part of a friction assembly for a braking system for railway rolling stock, said friction assembly further comprising a friction plate made of friction material comprising a first face which is the friction face, a second face which is adapted to be assembled to said lower face by an assembly mechanism, and at least one primary channel which connects said first face and said second face, said at least one connecting ring being adapted to be inserted in said at least one secondary channel and to establish a connection with said at least one primary channel as said at least one primary channel is aligned with one of said at least one secondary channel(s), said method comprising the following steps:
providing said block with a cavity which is connected by a circuit to the suction device, and with at least one hole which connects said cavity and said upper face and which is aligned with said at least one secondary channel;
providing a connecting plate, wherein said at least one connecting ring is removably mounted on said connecting plate;
positioning said connecting plate against the upper face of said brake head, and simultaneously inserting said at least one connecting ring in said at least one secondary channel by sliding along central axis A from said upper face, then placing said block on said connecting plate such that said connecting plate and said at least one connecting ring are together sandwiched between said brake head and said block;
removably securing said block to said brake head;
assembling said friction plate to said brake head by said assembly mechanism until said friction plate covers said secondary channels.

23. A method for mounting at least one connecting ring on a brake head comprising a lower face and an upper face, and having a connector block located at the upper face side and connected to a suction device, said brake head comprising at least one secondary channel of central axis A, said brake head and said connecting ring forming part of a friction assembly for a brake system for railway rolling stock, said friction assembly further comprising a friction plate made of friction material comprising a first face which is the friction face, a second face which is adapted to be assembled to said lower face by an assembly mechanism, and at least one primary channel which connects said first face and said second face, said at least one connecting ring being adapted to be inserted in said at least one secondary channel and to establish a connection with said at least one primary channel as said at least one primary channel is aligned with one of said at least one secondary channel(s), said method being comprising the following steps:
providing said block with a cavity which is connected by a circuit to the suction device, and with at least one hole which connects said cavity and said upper face and which is aligned with said at least one secondary channel, and said lower face is provided with a housing;
providing a connecting plate and removably mounting said at least one connecting ring on said connecting plate;
housing said connecting plate in said housing such that said connecting plate does not protrude from the lower face, and simultaneously inserting said at least one connecting ring in said at least one secondary channel by sliding along central axis A from said lower face, said connecting plate and said at least one connecting ring being removably secured to said brake head;
assembling said friction plate to said brake head by said assembly mechanism until said friction plate covers said secondary channels and said connecting plate.

24. The method according to claim 23, such that said block is an integral part of said brake head at said upper face.

25. The method according to claim 23, such that, during step “Providing said block”, said block is removably fixed to said brake head at its upper face.

26. The method according to claim 23, comprising, after step “Housing” and before step “assembling”:
mechanically securing said connecting plate to said brake head or to said block by means of a securing mechanism.
